(19) United States
(12) Patent Application Publication
(10) Pub. No.: US 2007/0092318 A1
(43) Pub. Date: Apr. 26, 2007

(54) Original document supply device for image forming device, and image forming device equipped with same

(76) Inventor: Hidehiro Tabuchi, Osaka (JP)

Correspondence Address: GLOBAL IP COUNSELORS, LLP, 1233 20TH STREET, NW, SUITE 700, WASHINGTON, DC, 20036-2680, US

(21) Appl. No.: 11/258,072

(22) Filed: Oct. 26, 2005

(51) Int. Cl. G03G 15/00

(52) U.S. Cl. 399/367

(57) ABSTRACT

This ADF 11 comprises an original document holding unit 31, a paper supply roller 51, and a lift plate drive unit 35. The original document holding unit 31 is capable of holding original documents and has a lift plate 41 capable of moving original documents to the loading direction. The paper supply roller 51 is capable of supplying an original document held in the lift plate 41. The lift plate drive unit 35 raises the lift plate 41 so that the original document abuts to the paper supply roller 51 when an original document is placed in the lift plate 41, and has the ability to lower the raised lift plate 41 when the next input operation is not performed within the prescribed time after an input operation is performed in regards to the operation panel 23.

### FIELD OF THE INVENTION

The present invention relates to an original document supply device for an image forming device and an image forming device equipped with same.

### BACKGROUND OF THE INVENTION

Image forming devices having copy functionality and equipped with an auto document feeder (hereinafter referred to as ADF) for supplying an original document into a document reading position have been becoming mainstream in recent years. In addition to the ADF being located opposite from the original document reading unit arranged on top of the main unit, it provides an original document holding unit and supplies original documents placed in the original document holding unit one sheet at a time into the document reading position of the original document reading unit.

A conventional ADF is already proposed having documents set with a vertically moveable lift plate which moves into the loading direction. The lift plate normally is in stand-by in the lower position when there is no document loaded but will be in stand-by in the upper position when a document is loaded and the front edge of the document abuts the paper supply roller.

Although this type of ADF is known for raising the lift plate after the start button on the main unit is pressed to indicate reading of the original document, the raising of the lift after pressing the start button demands a time requirement before printing can be initiated.

Therefore, a conventional type is proposed which allows for the raising of the lift plate immediately when the original document is set in preparation for the printing action. In this case, document reading can be initiated immediately by pressing the start button.

After printing instructions are given and all original documents are fed, read, and discharged, this type of original document supply device, normally, lowers the lift plate.

However, image forming devices generally provide an operation panel that includes a variety of operation keys in addition to a start button. A user can set the desired printing conditions by using the key operations on the operation panel.

Nevertheless, if a user decides to stop copying while in the middle of the setting operation, the lift plate remains abutted against the paper supply unit since the supply of the document did not complete. Accordingly, the next user must initiate lowering the lift plate once before setting their own document, and as a result, the printing operation is prolonged.

The objective of the present invention is to provide an easy method to add original documents and reset an image forming device capable of shortening the time required from printing instruction to printing action while also shortening the printing time for the following user thereafter.

### SUMMARY OF THE INVENTION

The original document supply device that relates to claim 1 is a device for supplying an original document into document reading position and is equipped on an image forming device having an input operation unit capable of predetermined input operations, and comprises an original document holding unit and a lift plate drive unit. The original holding unit can hold an original document and has a lift plate capable of moving original documents to the loading direction. The paper supply unit is capable of supplying an original document held in the lift plate. The lift drive unit is capable of raising the lift plate so as to abut the original document against the paper supply unit when an original document is placed in the lift plate, as well as lowering the raised lift plate when the next input operation is not performed within a predetermined time after performing an input operation in regards to an input operation unit.

When an original document is set, this device has the ability for the lift plate to be raised so that the original document abuts with the paper supply unit creating a condition where document supply is possible (supply enabled condition). When an operation is not performed within a predetermined time in this supply enabled condition, a non-copying state is recognized and the lift plate is lowered creating a space between the lift plate and the paper supply unit. Accordingly, because the lift is in a lowered state from the beginning, the next user attempting to print can immediately set the original documents thereby shortening the printing operation as a result.

The original document supply device that relates to claim 2 has the ability to set the prescribed time according to the input operation in regards to the input operations unit in the device given in claim 1.

With the original document supply device of the present invention, the lift plate may lower if the predetermined time elapses before completing the operation if, for example, the operation is prolonged or takes time while the user inputs the operation into the operation panel. For this reason, the device in claim 2 allows the user to execute a setting time freely as desired.

The original document supply device that relates to claim 3 has the ability for the input operation unit to enable a lift lowering mode setting and setting removal capability for lowering the lift plate when the next input operation is not performed within a predetermined time after performing an input operation in regards to an input operation unit in the device given in claim 1.

With the original document supply device of the present invention, certain users may desire that the lift plate is not lowered from the beginning as there is a time requirement to raise the lift plate before the printing operation can be performed when, for example, giving a printing instruction when the lift plate is in the lowered state. Therefore, a lift lowing mode setting removal is provided for these users with the device of claim 3 resulting in a wide selection available for all users.

The image forming device that relates to claim 4 comprises the original document supply device according to claim 1 and a main unit. The main unit has a document reading unit for reading an image of an original document while being arranged opposite to the original document supply device, an input operation unit capable of predetermined input operations, and an image forming unit for performing image formation based on the image information read by the document reading unit.

With this image forming device that provides the original document supply device given above, the user who next attempts to print can immediately set the original documents because the lift plate is in a lowered condition from the beginning, thereby allowing the printing operation to be shortened as a result.

According to the present invention, the user who next attempts to print can immediately set the original documents because the lift plate is in a lowered condition from the beginning, thereby allowing the printing operation to be shortened as a result.

### BRIEF DESCRIPTION OF THE DRAWINGS

FIG. 1 is a diagonal view drawing that shows the image forming device adopted by the first embodiment of the present invention.

FIG. 2 is a block diagram that shows the construction of the image forming device.

FIG. 3 is a vertical cross sectional drawing that shows the original document supply device for an image forming device.

FIG. 4 is a flowchart for explaining the action of the original document supply device.

### DETAILED DESCRIPTION OF THE PREFERRED EMBODIMENTS

Entire Composition of the Image Forming Device

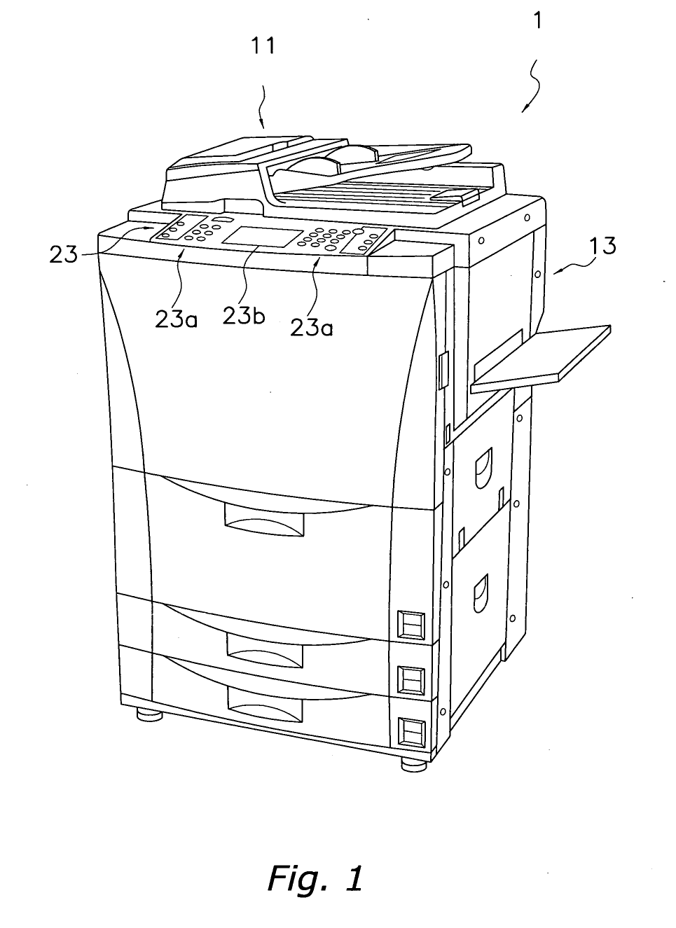

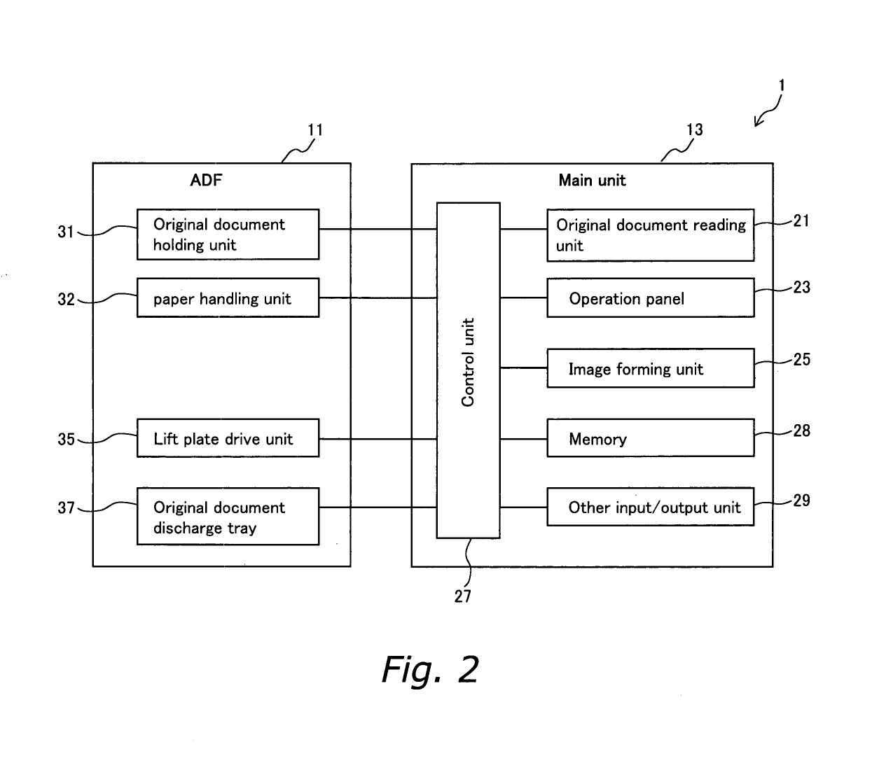

FIG. 1 and FIG. 2 show the image forming device 1 adopted by the first embodiment of the present invention.

The image forming device 1 is a multi-function device having the functions of a copying machine, printer, facsimile, and scanner together while comprising a main unit 13 and an ADF 11.

The main unit 13 has a document reading unit 21, operation panel (input operation unit) 23, image forming unit 25, control unit 27, memory 28, and another input/output unit 29.

The document reading unit 21 is for reading an image of the original document on a document platform not shown in the drawing, and is arranged on the top of the main unit 13 opposite to the ADF 11.

The operation panel 23 has a plurality of operation keys 23a and a display unit 23b constructed by a touch panel type liquid crystal display. Included in the plurality of operation keys 23a is the mode setting key for setting the lift lowering mode in addition to the start key for instructing the print operation, a ten key for inputting numerical values to set the predetermined time (described hereinafter), and the like. The lift lowering mode is a mode to activate the lowering of the lift plate 41 for the next user when an input operation in regards to the operation panel 23 has not been performed within a predetermined time, and can be set or removed according to the operation of the mode setting key.

The image forming unit 25 performs image formation based on the image information read by the original document reading unit 21, and it has a photo-sensitive drum, charging device arranged at the periphery thereof, exposure device, developing device and transcribing device or the like, and a fusing device arranged downstream thereof (none of which are shown in the drawing).

The control unit 27 is composed of a microcomputer that includes a CPU or the like, and controls the input/output unit of the original document reading unit 21. The control unit 27 has a timer function for counting a predetermined time (for instance, 30 seconds). More specifically, the control unit 27 resets the count of the predetermined time for each detection of an input operation in regards to the operation panel 23 (operation by the keys and on the display unit 23b) and initiates a new count.

The memory 28 is composed of a RAM and ROM, and stores each type of control program to be executed by the control unit 27.

The main unit 13 further comprises as the other input output unit 29, a communications unit for communicating with an externally connected device such as a personal computer or facsimile, a paper supply unit for supplying paper one sheet at a time from a paper cassette, and a paper discharge unit for discharging paper having underwent image formation by the image forming unit 25 (none of which are shown in the drawing).

Construction of the Original Document Supply Device

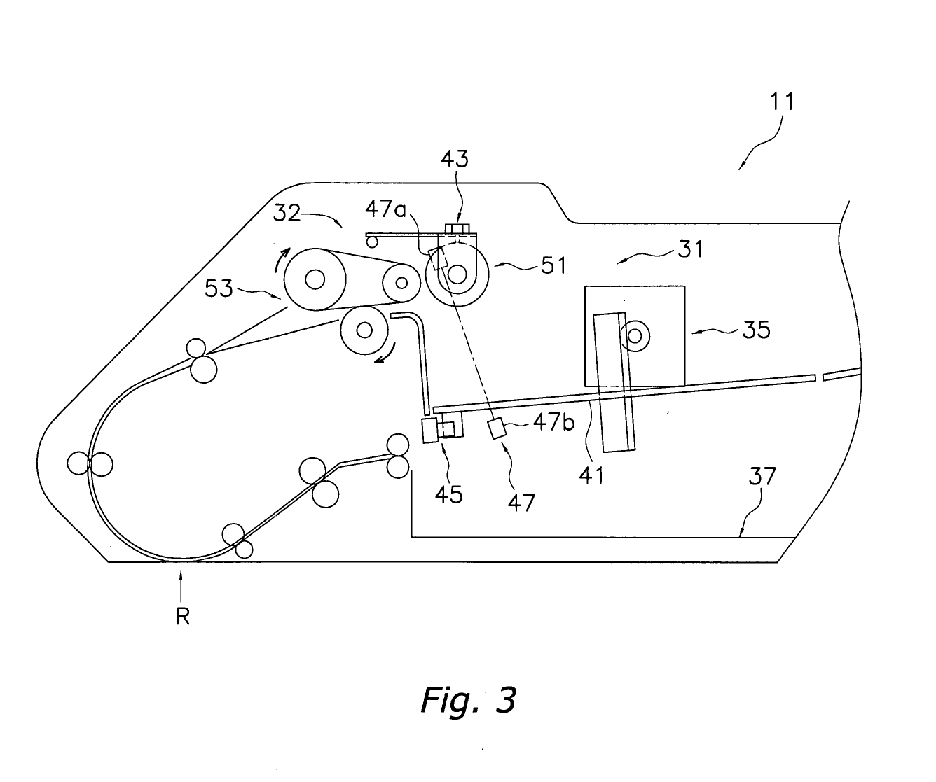

The ADF 11, as shown in FIG. 2 and FIG. 3, is a device for supplying an original document to the original document reading position R, and comprises an original document holding unit 31, a paper handling unit 32, a lift plate drive unit 35, and an original document discharge tray 37.

The original document holding unit 31 has a lift plate 41, an upper limit sensor 43, a lower limit sensor 45, and an original document set detection sensor 47.

The lift plate 41 is a plate shaped member with the ability to hold an original document, and can move to the upper limit in the loading direction of a document by the lift plate drive unit 35.

The upper limit sensor 43 is a sensor for stopping the rise of the lift plate 41 at a predetermined position, and is composed of an optical sensor. The upper limit sensor 43 optically senses when the original document on the lift plate 41 presses against the paper supply roller 51 (to be described hereafter) and stops the raising of the lift plate 41.

The lower limit sensor 45 is a sensor for detecting the lowering of the lift plate 41 at its maximum lowered position.

The original document set detection sensor 47 is a sensor for detecting that an original document has been set in the lift plate 41, and it has a light emitting unit 47a and a light receiving unit 47b, and it detects that the original document has been set when the original document blocks the light irradiated there between.

The paper handling unit 32 is for supplying the original document on the lift plate 41 and has a paper supply roller (paper supply unit) 51 and a separator roller 53.

The paper supply roller 51 is positioned at the lower position by its own weight in a free state and is arranged to open a space above the lift plate 41 arranged in the maximum lowered position, and is constructed to move tracking upwards by receiving a force from below from the lift plate 41. In this way, the paper supply roller 51 abuts to the edge of the original document set on the lift plate 41 when the lift plate 41 is in a paper supply enabled condition, and the original document is supplied to the original document reading position R when the start button is pressed.

The separator roller 53 is for preventing multi-feed by handling the original documents supplied by the paper supply roller 51.

The lift plate drive unit 35 is for raising and lowering the lift plate 41 and is composed of a stepping motor and a rack and pinion mechanism and so forth. The lift plate 41 is controlled by the control unit 27 in various manners. More specifically, the lift plate 41 is raised immediately creating the paper supply enabled condition when an original document is set in the lift plate 41, and in normal mode when the lift lowering mode settings are removed, the lift plate 41 is not lowered even when an input operation is not performed within the predetermined time, and in the lift lowering mode the lift plate 41 is lowered in a standby condition when an input operation is not performed within the predetermined time.

The original document discharge tray 37 is the location where the original document is discharged after reading is performed at the original document reading position R.

Operation of the Image Forming Device

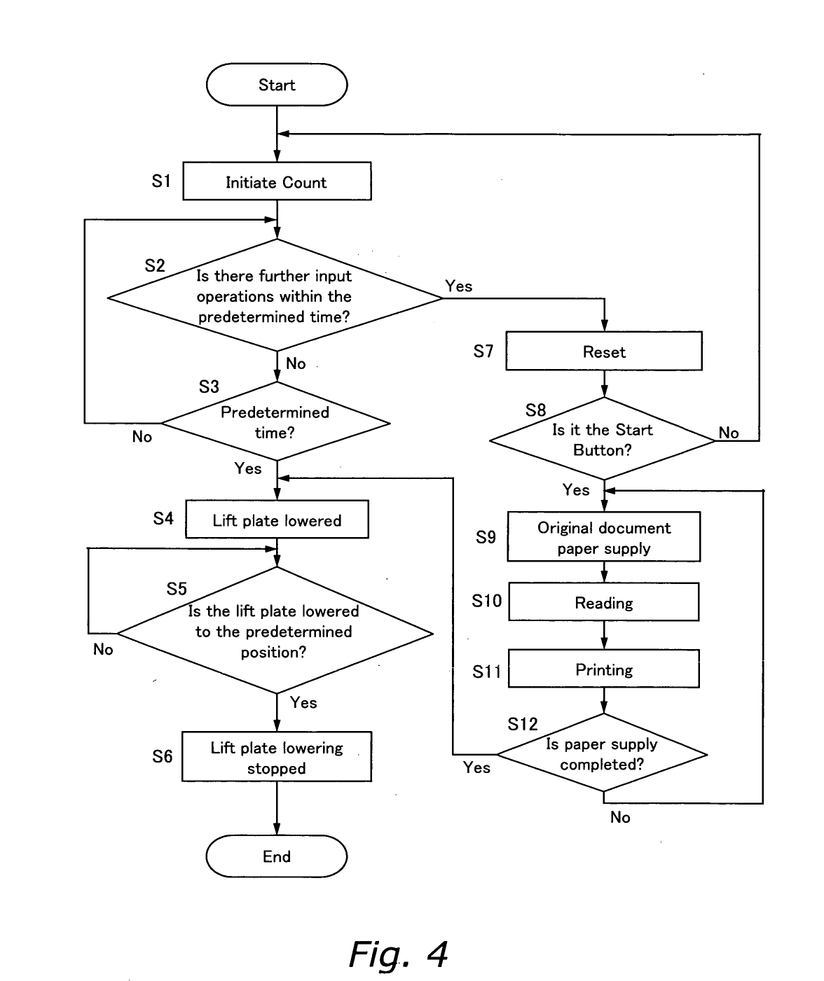

A description is given hereinafter of one example of the operation of the image forming device 1 based on FIG. 4.

A description is given hereinafter of an example when the lift lowering mode is set.

With the image forming device 1, the count of the predetermined time is initiated by a timer (S1) when an original document is set in the lift plate 41 and the lift plate 41 is raised creating the paper supply enabled condition. If the input operation is not performed within the prescribed time (S2), the prescribed time elapses (S3), and the lift plate 41 is lowered (S4). When the lift plate 41 is lowered to a predetermined position in a standby condition (S5), the lowering of the lift plate 41 is stopped (S6).

In step S2, meanwhile, when the input operation is performed prior to the elapsing of the predetermined time, the time count is reset (S7). Further, when the input operation is the start button (S8), the paper supply roller 51 activates and the original document is fed onto the lift plate 41(S9) where the image information of the original document is read in the original document reading position R (S10) and printing operation is performed in accordance with the set printing conditions (S11). When all of the original documents have been fed (S 12), the process moves to step S4 where the lift plate 41 is lowered.

Moreover, any user can set the lift plate to not lower even when exceeding the predetermined time by removing the lift lowering mode setting using the mode setting key.

According to the image forming device 1 given above, the next user attempting to print can immediately set an original document because the lift plate is lowered from the beginning in a standby condition thereby shortening the printing operation as a result.

### Other Embodiments

(a) The embodiment described above can also be constructed so that when some input operation is performed even in the middle of lowering the lift plate after the predetermined time has elapsed, the stepping motor can be reversed to raise the lift plate so as to create the paper supply enabled condition.
(b) The control unit may also place a portion of the instructional system within the ADF, and when doing so, the count for the predetermined time may also be performed by the instructional system within the ADF.
(c) The composition of each of the various sensors in the ADF is not restricted to those given above. For instance, the lower limit switch may not be used.
(d) The original document supplied device of the present invention can be applied to types capable of duplex reading having a reversible function.

What is claimed is:

1. An original document supply device for supplying an original document into document reading position and is equipped on an image forming device having an input operation unit capable of predetermined input operations, comprising: an original document holding unit capable of holding original documents as well as having a lift plate capable of moving documents to the loading direction; a paper supply unit capable of supplying an original document held in the lift plate; and a lift drive unit capable of raising the lift plate so as to abut the original document against the paper supply unit when an original document is placed in the lift plate, as well as lowering the raised lift plate when the next input operation is not performed within a predetermined time after performing an input operation in regards to an input operation unit.

2. An original document supply device according to claim 1, wherein the prescribed time can be set according to the input operation in regards to the input operations unit.

3. An original document supply device according to claim 1, wherein the input operation unit enables a lift lowering mode setting and setting removal capability for lowering the lift plate when the next input operation is not performed within a predetermined time after performing an input operation in regards to an input operation unit.

4. An image forming device, comprising: the original document supply device of the image forming device according to claim 1; and a main unit having a document reading unit for reading an image of an original document while being arranged opposite to the original document supply device, an input operation unit capable of predetermined input operations, and an image forming unit for performing image formation based on the image information read by the document reading unit.
